(19) United States
(12) Patent Application Publication
(10) Pub. No.: US 2014/0150647 A1
(43) Pub. Date: Jun. 5, 2014

(54) Curable Silicate-Siloxane Mixed Matrix Membrane Compositions

(71) Applicants: Dongchan Ahn, Midland, MI (US); Christopher L. Wong, Los Angeles, CA (US)

(72) Inventors: Dongchan Ahn, Midland, MI (US); Christopher L. Wong, Los Angeles, CA (US)

(73) Assignee: Dow Corning Corporation, Midland, MI (US)

(21) Appl. No.: 13/976,627

(22) PCT Filed: Dec. 22, 2011
(86) PCT No.: PCT/US11/66930

§ 371 Date: Feb. 18, 2014

Related U.S. Application Data
(60) Provisional application No. 61/427,238, filed on Dec. 27, 2010.

(51) Int. Cl. B01D 71/70; B01D 53/22

(52) U.S. Cl. CPC B01D 71/70; B01D 53/228
USPC 95/51; 95/45; 252/183.11

(57) ABSTRACT

In various embodiments, provided are modified silicone compositions comprising at least one curable silicone composition and at least one silicon additive; cured products of such compositions; oxidized products of such cured products; and membranes comprising one or both of the cured or oxidized products, said membranes having the requisite permeability and selectivity for separating mixtures of gases. Also provided are methods of preparing the provided compositions, cured products, oxidized products, and membranes.

### TECHNICAL FIELD

The present disclosure relates to modified silicone compositions; cured products of such compositions; oxidized products of such cured products; and membranes comprising the cured or oxidized products, said membranes having the requisite permeability and selectivity for separating mixtures of gases. The disclosure also relates to methods of preparing the provided compositions, cured products, oxidized products, and membranes.

### BACKGROUND

Industrial processes designed to separate certain components from a mixture of gases figure prominently in purification applications, production of fuels, and other applications where components need to be removed or otherwise separated. For example, gas separations are critical in technologies such as recovery of natural gas reserves and the capture of carbon dioxide from power plants. Conventional gas separation processes are based upon distillation or adsorption processes. Examples include cryo-distillation, pressure swing adsorption, amine absorption, and adsorption by physical solvents. While these techniques may be effective, they suffer from high energy consumption because phase changes are required to reversibly convert at least one of the gases to a condensed state.

Membrane-based gas separation offers a way to avoid the energy intensive phase transition because membranes selectively allow certain gases to pass through the membrane in the gaseous state in a continuous manner. This potential for reduced energy consumption, coupled with the modularity, small physical footprint, and reduced environmental footprint (for example, there is reduced need to transport, pump and dispose of toxic chemicals) of membranes has made membrane-based gas separation an attractive alternative to conventional gas separations. Challenges remain, however, in the development of materials suitable for use in membranes that can be used in such separations.

Two critical parameters that determine a material's effectiveness as a membrane for separating gaseous species are permeability coefficient (P) and ideal selectivity or separation factor (α). For example, parameters that determine a material's effectiveness as a membrane for separating gases A and B are P_{A}, which is a partial pressure- and thickness-normalized flux for the faster permeating gas A, and α_{A/B}, which is the ratio of the permeability coefficients of gas A to gas B. Generally, the higher the permeability and selectivity for a given gas pair, the more effective a material will be as a membrane for separating gas A from gas B. However, there is a nearly universal inverse relationship between P_{A} and α_{A/B} for most polymer-based membrane materials. While membranes have been successfully used in applications such as natural gas and ammonia recovery processes, this trade-off relationship has effectively placed a practical limit on the growth and maturation of membrane-based gas separations for large volume separations.

Some experimental materials have shown unusually high permeability and selectivity but are not viable for most applications because of difficulties in processing them into thin films of high surface area geometry, such as spiral wound sheets or hollow fibers. As one example, applications such as natural gas processing and carbon capture from post-combustion flue gas in power plants, require the efficient removal of carbon dioxide from mixed gas streams. In such applications, it is desirable to have both a high CO₂ permeability and selectivity relative to the other primary gases in the stream such as methane or nitrogen. However, there remains a need for efficient processes that can separate mixed gas streams based upon materials that offer a combination of high permeability and selectivity for gases such as CO₂, while being able to be processed into thin films or fibers. Thus, there remains a need for materials that have a combination of high permeability and selectivity and are able to be processed into thin films or fibers, and are suitable for use in membranes for gas separations.

### SUMMARY

These needs are met by embodiments of the present disclosure, which provide modified silicone compositions comprising (i) at least one curable silicone composition and (ii) at least one silicon additive. Also provided are cured products of the provided compositions, oxidized products of said cured products, and membranes comprising such cured or oxidized products. Additionally provided are methods of preparing the provided modified silicone compositions, cured products, oxidized products, and membranes. In some embodiments, such membranes offer a combination of high permeability and selectivity and are able to be processed into thin films or fibers.

In various embodiments, the provided modified silicone compositions comprise a silicon additive that is prepared by a method comprising reacting an amine-functional silane, an amine-reactive compound having at least one free-radical polymerizable group per molecule, and an organoborane free-radical initiator. The amine-functional silane used has the formula:

(R¹₂NR²)ₐSiR³_{b}(OR⁴)_{4-(a+b)} (I)

wherein a=1, 2, or 3; b=0, 1, 2, or 3; a+b=1, 2, 3, or 4; R¹ is independently selected from hydrogen, C1-C12 alkyl, halogen-substituted C1-C12 alkyl, C1-C12 cycloalkyl, aryl, nitrogen-substituted C1-C12 alkyl, and aliphatic ring structures which bridge both R¹ units and can be N-substituted; R² is independently selected from C1-C30 alkyl; R³ is independently selected from hydrogen, halogen, C1-C12 alkyl, halogen-substituted C1-C12 alkyl, and —OSiR^{3′}₃, wherein R^{3′} is selected from C1-C12 alkyl, and halogen-substituted C1-C12 alkyl; and R⁴ is independently selected from hydrogen, C1-C12 alkyl, and halogen-substituted C1-C12 alkyl. In some embodiments, the reaction may occur in the presence of at least one optional solvent.

In various embodiments, the provided modified silicone compositions may be treated with heat, moisture, radiation, or combinations thereof to form cured products. Said cured products may, in some embodiments, be used for preparing membranes having the requisite permeability and selectivity for separating mixtures of gases. In alternative embodiments, the cured products may be treated with heat, acid, or combinations thereof to form oxidized products. Said oxidized products may, in some embodiments, be used for preparing membranes having the requisite permeability and selectivity for separating mixtures of gases.

### BRIEF DESCRIPTION OF THE DRAWINGS

A more complete appreciation of the invention and the many embodiments thereof will be readily obtained as the same becomes better understood by reference to the following detailed description when considered in connection with the accompanying drawings, wherein:

FIG. 1 is a flow chart describing steps of various embodiments of methods for preparing modified silicone compositions, cured products thereof, and oxidized products of the cured products;

FIG. 2 is a flow chart describing steps of certain embodiments of methods for preparing modified silicone compositions, cured products thereof, and oxidized products of the cured products. In some embodiments, illustrated are methods of preparing a silicon additive in situ by combining a free-radical polymerizable amine-reactive compound, an amine-functional silane, and an organoborane free-radical initiator in the presence of oxygen, wherein the amine-reactive compound and amine-functional silane react to form a reaction product (not labeled) and the organoborane initiates polymerization of the reaction product to form the silicon additive (not labeled), all of which is done in the presence of a curable silicone composition;

FIG. 3 is a flow chart describing steps of certain embodiments of methods for preparing modified silicone compositions, cured products thereof, and oxidized products of the cured products. In some embodiments, illustrated are methods of preparing a silicon additive by combining an organoborane free-radical initiator (in the presence of oxygen) and a reaction product of a free-radical polymerizable amine-reactive compound and an amine-functional silane, wherein the organoborane initiates polymerization of the reaction product to form the silicon additive (not labeled), and wherein formation of the silicon additive is done in the presence of a curable silicone composition;

FIG. 4 is a flow chart describing steps of certain embodiments of methods for preparing modified silicone compositions, cured products thereof, and oxidized products of the cured products. In some embodiments, illustrated are methods of preparing a silicon additive by reacting a free-radical polymerizable amine-reactive compound and an amine-functional silane to form a reaction product, and treating the reaction product with an organoborane free-radical initiator (in the presence of oxygen) to form a polymer preparation (silicon additive); and

FIG. 5 is a flow chart describing steps of certain embodiments of methods for preparing modified silicone compositions, cured products thereof, and oxidized products of the cured products. In some embodiments, illustrated are methods of preparing a silicon additive by reacting a free-radical polymerizable amine-reactive compound and an amine-functional silane to form a reaction product, treating the reaction product with an organoborane free-radical initiator (in the presence of oxygen) to form a polymer preparation, and treating the polymer preparation with heat, acid, or combination thereof to form an oxidized product (silicon additive).

### DETAILED DESCRIPTION

Features and advantages of the invention will now be described with occasional reference to specific embodiments. However, the invention may be embodied in different forms and should not be construed as limited to the embodiments set forth herein. Rather, these embodiments are provided so that this disclosure will be thorough and complete and will fully convey the scope of the invention to those skilled in the art.

Unless otherwise defined, all technical and scientific terms used herein have the same meaning as commonly understood by one of ordinary skill in the art to which the invention belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

The term “independently selected from,” as used in the specification and appended claims, is intended to mean that the referenced groups can be the same, different, or a mixture thereof, unless the context clearly indicates otherwise. Thus, under this definition, the phrase “X¹, X², and X³ are independently selected from noble gases” would include the scenario where X¹, X², and X³ are all the same, where X¹, X², and X³ are all different, and where X¹ and X² are the same but X³ is different.

Unless the context clearly indicates otherwise, the term “porous” is used herein and in the appended claims to mean one or more of microporous (mean pore diameter of less than 2 nm), mesoporous (mean pore diameter of from about 2-50 nm), and macroporous (mean pore diameter of greater than 50 nm).

As used herein and the appended claims, the term “powder” is intended to mean granulated particles of a bulk solid.

Unless the context clearly indicates otherwise, the term “silicone” is used herein and the appended claims to refer to organopolysiloxanes that can be linear, branched, hyperbranched, or resinous in nature.

The terms “solid” and “bulk solid,” as used herein and the appended claims, are intended to mean a solid that can be further granulated into particles of any size and shape distribution.

As used herein and the appended claims, the term “membrane” is intended to mean films that permit the permeation of at least one component across the thickness of the film. Membranes may comprise dense materials, porous materials, or combination of dense and porous materials. Membranes include, but are not limited to, hollow fiber membranes, spiral-wound membranes, flat membranes, and substantially flat membranes. Moreover, a membrane may be free-standing or supported.

As used herein and the appended claims, the term “cure” and variations thereof refer to the conversion of a liquid or semisolid composition to a cross-linked product.

As used herein and the appended claims, the term “react” is used generally and is intended to be given the broadest reasonable interpretation possible. For example, the term may be used herein to describe use of an organoborane free radical generator to catalyze a polymerization reaction.

Unless otherwise indicated, all numbers expressing quantities of ingredients, properties such as molecular weight, reaction conditions, and so forth as used in the specification and claims are to be understood as being modified in all instances by the term “about.” Additionally, the disclosure of any ranges in the specification and claims are to be understood as including the range itself and also anything subsumed therein, as well as endpoints. Unless otherwise indicated, the numerical properties set forth in the specification and claims are approximations that may vary depending on the desired properties sought to be obtained in embodiments of the present invention. Notwithstanding that numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In various embodiments, the present disclosure provides modified silicone compositions comprising (i) at least one curable silicone composition and (ii) at least one silicon additive. The silicon additive may be prepared by a method comprising reacting an amine-functional silane, an amine-reactive compound having at least one free-radical polymerizable group per molecule, and an organoborane free-radical initiator. The amine-functional silane used has the formula:

(R¹₂NR²)ₐSiR³_{b}(OR⁴)_{4-(a+b)} (I)

wherein a=1, 2, or 3; b=0, 1, 2, or 3; a+b=1, 2, 3, or 4; R¹ is independently selected from hydrogen, C1-C12 alkyl, halogen-substituted C1-C12 alkyl, C1-C12 cycloalkyl, aryl, nitrogen-substituted C1-C12 alkyl, and aliphatic ring structures which bridge both R¹ units and can be N-substituted; R² is independently selected from C1-C30 alkyl; R³ is independently selected from hydrogen, halogen, C1-C12 alkyl, halogen-substituted C1-C12 alkyl, and —OSiR^{3′}₃, wherein R^{3′} is selected from C1-C12 alkyl, and halogen-substituted C1-C12 alkyl; and R⁴ is independently selected from hydrogen, C1-C12 alkyl, and halogen-substituted C1-C12 alkyl.

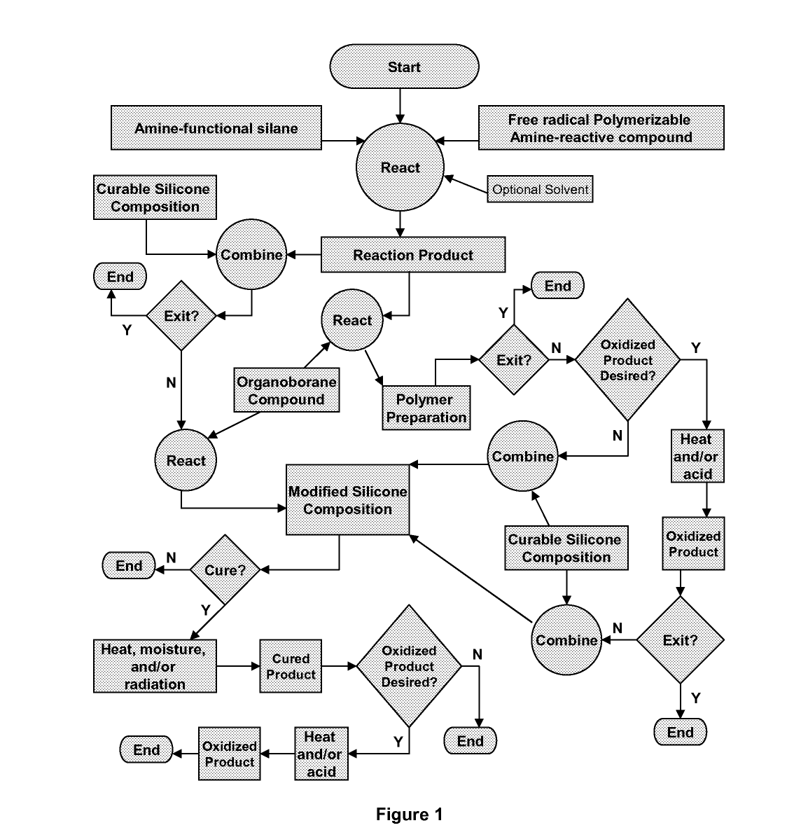

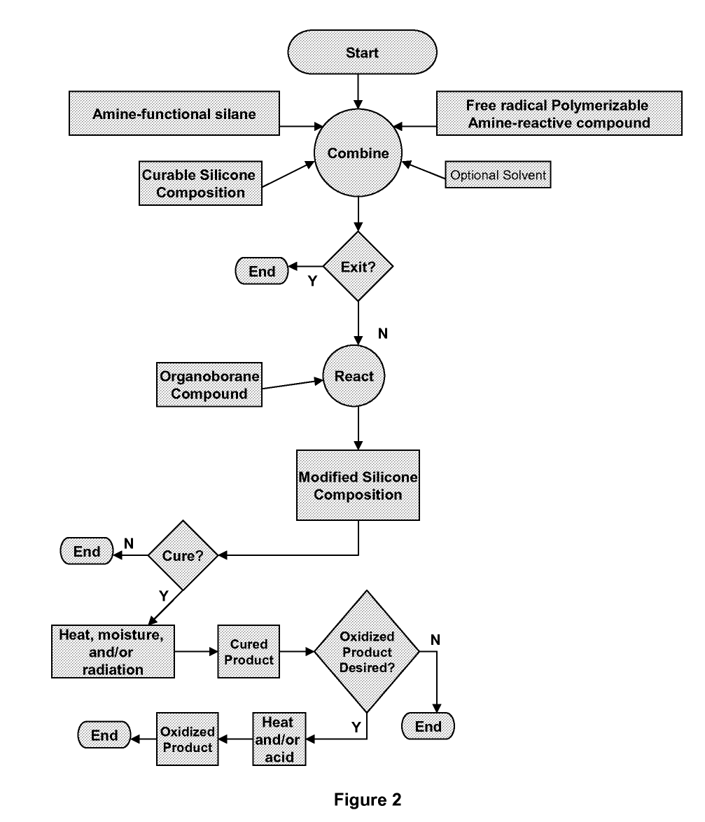

In the various embodiments, the silicon additive is prepared by a method comprising reacting the amine-functional silane and amine-reactive compound to form a reaction product. Optionally, the reaction may occur in the presence of at least one optional solvent to form a reaction product that is soluble in the at least one optional solvent. As illustrated in FIGS. 1-2 there are numerous methods of preparing the silicon additive. In some embodiments, the reaction product formed may be combined with the curable silicone composition and said combination treated with an organoborane free-radical initiator in the presence of oxygen, thereby allowing the organoborane to catalyze the polymerization of the reaction product to form the silicon additive in the presence of the curable silicone composition. In alternative embodiments, the reaction product formed from the reaction of the amine-functional silane and amine-reactive compound may be treated with the organoborane free-radical initiator in the presence of oxygen to form a polymer preparation. The polymer preparation formed may either (i) be used as a silicon additive and combined with the curable silicone composition to form a modified silicone composition; or (ii) oxidized by heat, acid, or both and the oxidized product formed (silicon additive that is a powder or solid) combined with the curable silicone composition to form a modified silicone composition.

While the above-described methods involve reacting the amine-functional silane and amine-reactive compound prior to combination with the curable silicone composition, it is also an embodiment of the present disclosure to prepare the silicon additive in situ by combining the amine-functional silane, amine-reactive compound, and organoborane initiator in the presence of oxygen and a curable silicone composition (optionally, in the presence of at least one solvent).

In various embodiments, provided are cured products of the provided modified silicone compositions. Cure may be achieved by a method comprising treating the modified silicone composition formed with heat, moisture, radiation, or combinations thereof. The cured products formed may be used in a variety of applications including, but not limited to, as membranes. In some embodiments, the cured products may be oxidized by a method comprising treating the cured product with heat, acid, or combinations thereof. The oxidized products formed may be used in a variety of applications including, but not limited to, as membranes.

In various embodiments, additionally provided are membranes comprising the provided cured products, the provided oxidized products, or combinations thereof, said membranes having the requisite permeability and selectivity for separating mixtures of gases.

### I. Curable Silicone Compositions

The provided modified silicone compositions comprise at least one curable silicone composition and at least one silicon additive. Curable silicone compositions generally comprise at least one curable organopolysiloxane and a curing catalyst or initiator. Such compositions and methods for their preparation are well known in the art. Examples include, but are not limited to, hydrosilylation-curable silicone compositions, peroxide-curable silicone compositions, condensation-curable silicone compositions, epoxy-curable silicone compositions; ultraviolet radiation-curable silicone compositions, and high-energy radiation-curable silicone compositions.

Curable organopolysiloxanes comprise organic functional groups needed for curing the curable silicone compositions. Additionally, such organopolysiloxanes may comprise silicon-bonded monovalent organic groups free of the organic functional groups needed for curing. These monovalent organic groups may have 1 to 20 carbon atoms, and are exemplified by, but not limited to alkyl groups such as methyl, ethyl, propyl, pentyl, octyl, undecyl, and octadecyl; cycloalkyl groups such as cyclohexyl; aryl groups such as phenyl, tolyl, xylyl, benzyl, and 2-phenylethyl; cyano-functional groups such as cyanoalkyl groups exemplified by cyanoethyl and cyanopropyl; and halogenated hydrocarbon groups such as 3,3,3-trifluoropropyl, 3-chloropropyl, dichlorophenyl, and 6,6,6,5,5,4,4,3,3-nonafluorohexyl.

Curable organopolysiloxanes may have a viscosity of 0.001 to 500 Pa·s at 25° C.; alternatively 0.005 to 200 Pa·s at 25° C. They may also be solids that become flowable at elevated temperatures, such as the temperatures used for polymer processing.

In some embodiments, the at least one curable silicone composition of the provided modified silicone compositions may comprise an organopolysiloxane fluid selected from:

R⁵₃SiO(R⁵₂SiO)_{α}(R⁵R⁶SiO)_{β}SiR⁵₃; (II)

R⁷₂R⁸SiO(R⁷₂SiO)_{χ}(R⁷R⁸SiO)_{δ}SiR⁷₂R⁸; and combinations thereof. (III)

In formula (II), α has an average value of 0 to 2000, and β has an average value of 1 to 2000. Each R⁵ is independently hydrogen or a monovalent organic group. Suitable monovalent organic groups include, but are not limited to, acrylic functional groups such as acryloyloxypropyl and methacryloyloxypropyl; alkyl groups such as methyl, ethyl, propyl, and butyl; alkenyl groups such as vinyl, allyl, and butenyl; alkynyl groups such as ethynyl and propynyl; aromatic groups such as phenyl, tolyl, and xylyl; cyanoalkyl groups such as cyanoethyl and cyanopropyl; halogenated hydrocarbon groups such as 3,3,3-trifluoropropyl, 3-chloropropyl, dichlorophenyl, and 6,6,6,5,5,4,4,3,3-nonafluorohexyl; alkyloxypoly(oxyalkyene) groups such as propyloxy(polyoxyethylene), propyloxypoly(oxypropylene) and propyloxy-poly(oxypropylene)-co-poly(oxyethylene); alkoxy such as methoxy, ethoxy, n-propoxy, isopropoxy, n-butoxy and ethylhexyloxy; aminoalkyl groups such as 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine, and 3-propylpyrrole; epoxyalkyl groups such as 3-glycidoxypropyl, 2-(3,4,-epoxycyclohexyl)ethyl, and 5,6-epoxyhexyl; ester functional groups such as actetoxymethyl and benzoyloxypropyl; hydroxyl functional groups such as hydroxy and 2-hydroxyethyl, isocyanate and masked isocyanate functional groups such as 3-isocyanatopropyl, tris-3-propylisocyanurate, propyl-t-butylcarbamate, and propylethylcarbamate; aldehyde functional groups such as undecanal and butyraldehyde; anhydride functional groups such as 3-propyl succinic anhydride and 3-propyl maleic anhydride; carboxylic acid functional groups such as 3-carboxypropyl and 2-carboxyethyl; and metal salts of carboxylic acids such as the Zn, Na or K salts of 3-carboxypropyl and 2-carboxyethyl. Each R⁶ is independently hydrogen or a reactive (with respect to the curing reaction) monovalent organic group. For example in the case of a hydrosilylation curable silicone composition, the R⁶ is exemplified by hydrogen or alkenyl groups such as vinyl, allyl, and butenyl; alkynyl groups such as ethynyl and propynyl; and acrylic functional groups such as acryloyloxypropyl and methacryloyloxypropyl.

In formula (III), χ has an average value of 0 to 2000, and δ has an average value of 0 to 2000. Each R⁷ is independently hydrogen or a monovalent organic group. Suitable monovalent organic groups include, but are not limited to, acrylic functional groups such as acryloyloxypropyl and methacryloyloxypropyl; alkyl groups such as methyl, ethyl, propyl, and butyl; alkenyl groups such as vinyl, allyl, and butenyl; alkynyl groups such as ethynyl and propynyl; aromatic groups such as phenyl, tolyl, and xylyl; cyanoalkyl groups such as cyanoethyl and cyanopropyl; halogenated hydrocarbon groups such as 3,3,3-trifluoropropyl, 3-chloropropyl, dichlorophenyl, and 6,6,6,5,5,4,4,3,3-nonafluorohexyl; alkyloxypoly(oxyalkyene) groups such as propyloxy(polyoxyethylene), propyloxypoly(oxypropylene) and propyloxy-poly(oxypropylene)-co-poly(oxyethylene); alkoxy such as methoxy, ethoxy, n-propoxy, isopropoxy, n-butoxy and ethylhexyloxy; aminoalkyl groups such as 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine, and 3-propylpyrrole; hindered aminoalkyl groups such as tetramethylpiperidinyloxypropyl; epoxyalkyl groups such as 3-glycidoxypropyl, 2-(3,4,-epoxycyclohexyl)ethyl, and 5,6-epoxyhexyl; ester functional groups such as actetoxymethyl and benzoyloxypropyl; hydroxyl functional groups such as hydroxy and 2-hydroxyethyl, isocyanate and masked isocyanate functional groups such as 3-isocyanatopropyl, tris-3-propylisocyanurate, propyl-t-butylcarbamate, and propylethylcarbamate; aldehyde functional groups such as undecanal and butyraldehyde; anhydride functional groups such as 3-propyl succinic anhydride and 3-propyl maleic anhydride; carboxylic acid functional groups such as 3-carboxypropyl, 2-carboxyethyl and 10-carboxydecyl; and metal salts of carboxylic acids such as the Zn, Na or K salts of 3-carboxypropyl and 2-carboxyethyl. Each R⁸ is independently hydrogen or a reactive (with respect to the curing reaction) monovalent organic group. For example in the case of a hydrosilylation curable silicone composition, the R⁸ is exemplified by hydrogen or alkenyl groups such as vinyl, allyl, and butenyl; alkynyl groups such as ethynyl and propynyl; and acrylic functional groups such as acryloyloxypropyl and methacryloyloxypropyl.

Methods of preparing organopolysiloxane fluids suitable for use in curable silicone compositions, such as hydrolysis and condensation of the corresponding organohalosilanes or equilibration of cyclic polydiorganosiloxanes, are known.

In some embodiments, suitable curable silicone compositions may comprise organosiloxane resins such as an MQ resin consisting essentially of R⁹₃SiO_{1/2} units and SiO_{4/2} units, a TD resin consisting essentially of R⁹SiO_{3/2} units and R⁹₂SiO_{2/2} units, an MT resin consisting essentially of R⁹₃SiO_{1/2} units and R⁹SiO_{3/2} units, an MTD resin consisting essentially of R⁹₃SiO_{1/2} units, R⁹SiO_{3/2} units, and R⁹₂SiO_{2/2} units, or a combination thereof. Each R⁹ is hydrogen or a monovalent organic group. The monovalent organic groups represented by R⁹ may have 1 to 20 carbon atoms, alternatively 1 to 10 carbon atoms. Examples of monovalent organic groups include, but are not limited to, acrylate functional groups such as acryloxyalkyl groups, methacrylate functional groups such as methacryloxyalkyl groups, cyano-functional groups, and monovalent hydrocarbon groups. Monovalent hydrocarbon groups include, but are not limited to, alkyl such as methyl, ethyl, propyl, pentyl, octyl, undecyl, and octadecyl; cycloalkyl such as cyclohexyl; alkenyl such as vinyl, allyl, butenyl, and hexenyl; alkynyl such as ethynyl, propynyl, and butynyl; aryl such as phenyl, tolyl, xylyl, benzyl, and 2-phenylethyl; halogenated hydrocarbon groups such as 3,3,3-trifluoropropyl, 3-chloropropyl, dichlorophenyl, and 6,6,6,5,5,4,4,3,3-nonafluorohexyl. Cyano-functional groups include, but are not limited to, cyanoalkyl groups such as cyanoethyl and cyanopropyl. Also included are alkyloxypoly(oxyalkyene) groups such as propyloxy(polyoxyethylene), propyloxypoly(oxypropylene) and propyloxy-poly(oxypropylene)-co-poly(oxyethylene); alkoxy groups such as methoxy, ethoxy, n-propoxy, isopropoxy, n-butoxy and ethylhexyloxy; aminoalkyl groups such as 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine and 3-propylpyrrole; hindered aminoalkyl groups such as tetramethylpiperidinyloxypropyl; epoxyalkyl groups such as 3-glycidoxypropyl, 2-(3,4,-epoxycyclohexyl)ethyl, and 5,6-epoxyhexyl; ester functional groups such as actetoxymethyl and benzoyloxypropyl; hydroxyl functional groups such as hydroxy and 2-hydroxyethyl, isocyanate and masked isocyanate functional groups such as 3-isocyanatopropyl, tris-3-propylisocyanurate, propyl-t-butylcarbamate, and propylethylcarbamate; aldehyde functional groups such as undecanal and butyraldehyde; anhydride functional groups such as 3-propyl succinic anhydride and 3-propyl maleic anhydride; carboxylic acid functional groups such as 3-carboxypropyl, 2-carboxyethyl, and 10-carboxydecyl; and metal salts of carboxylic acids such as the Zn, Na or K salts of 3-carboxypropyl and 2-carboxyethyl.

Methods of preparing organosiloxane resins are known. For example, a resin may be prepared by treating a resin copolymer produced by the silica hydrosol capping process of Daudt et al. with at least an alkenyl-containing endblocking reagent. The method of Daudt et al., is disclosed in U.S. Pat. No. 2,676,182. Briefly stated, the method of Daudt et al. involves reacting a silica hydrosol under acidic conditions with a hydrolyzable triorganosilane such as trimethylchlorosilane, a siloxane such as hexamethyldisiloxane, or mixtures thereof, and recovering a copolymer having M and Q units. The resulting copolymers generally contain from 2 to 5 percent by weight of silicon-bonded hydroxyl groups.

Examples of suitable curable silicone compositions for inclusion in the provided modified silicone compositions include, but are not limited to, hydrosilylation-curable silicone compositions, peroxide-curable silicone compositions, condensation-curable silicone compositions, epoxy-curable silicone compositions; ultraviolet radiation-curable silicone compositions, and high-energy radiation-curable silicone compositions. Suitable hydrosilylation-curable silicone compositions typically comprise (i) an organopolysiloxane containing an average of at least two silicon-bonded alkenyl groups per molecule, (ii) an organohydrogensiloxane containing an average of at least two silicon-bonded hydrogen atoms per molecule in an amount sufficient to cure the composition, and (iii) a hydrosilylation catalyst. The hydrosilylation catalyst can be any of the well-known hydrosilylation catalysts comprising a group VIIIB metal, a compound containing a group VIIIB metal, or a microencapsulated group VIIIB metal-containing catalyst. Group VIIIB metals include platinum, rhodium, ruthenium, palladium, osmium and iridium. Preferably, the group VIIIB metal is platinum, based on its high activity in hydrosilylation reactions.

A hydrosilylation-curable silicone composition can be a one-part composition or a multi-part composition comprising the components in two or more parts. Room-temperature vulcanizable (RTV) compositions typically comprise two parts, one part containing the organopolysiloxane and catalyst and another part containing the organohydrogensiloxane and any optional ingredients. Hydrosilylation-curable silicone compositions that cure at elevated temperatures can be formulated as one-part or multi-part compositions. For example, liquid silicone rubber (LSR) compositions are typically formulated as two-part systems. One-part compositions typically contain a platinum catalyst inhibitor to ensure adequate shelf life.

Suitable peroxide-curable silicone compositions typically comprise (i) an organopolysiloxane and (ii) an organic peroxide. Examples of organic peroxides include, diaroyl peroxides such as dibenzoyl peroxide, di-p-chlorobenzoyl peroxide, and bis-2,4-dichlorobenzoyl peroxide; dialkyl peroxides such as di-t-butyl peroxide and 2,5-dimethyl-2,5-di-(t-butylperoxy)hexane; diaralkyl peroxides such as dicumyl peroxide; alkyl aralkyl peroxides such as t-butyl cumyl peroxide and 1,4-bis(t-butylperoxyisopropyl)benzene; and alkyl aroyl peroxides such as t-butyl perbenzoate, t-butyl peracetate, and t-butyl peroctoate.

Suitable condensation-curable silicone compositions typically comprise (i) an organopolysiloxane containing an average of at least two hydroxy groups or two alkoxysilyl groups per molecule; and (ii) a tri- or tetra-functional silane containing hydrolysable Si—O or Si—N bonds. Examples of silanes include alkoxysilanes such as CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHSi(OCH₃)₃, CH₂═CHCH₂Si(OCH₃)₃, CF₃CH₂CH₂Si(OCH₃)₃, CH₃Si(OCH₂CH₂OCH₃)₃, CF₃CH₂CH₂Si(OCH₂CH₂OCH₃)₃, CH₂═CHSi(OCH₂CH₂OCH₃)₃, CH₂═CHCH₂Si(OCH₂CH₂OCH₃)₃, C₆H₅Si(OCH₂CH₂OCH₃)₃, Si(OCH₃)₄, Si(OC₂H₅)₄, and Si(OC₃H₇)₄; organoacetoxysilanes such as CH₃Si(OCOCH₃)₃, CH₃CH₂Si(OCOCH₃)₃, and CH₂═CHSi(OCOCH₃)₃; organoiminooxysilanes such as CH₃Si[O—N═C(CH₃)CH₂CH₃]₃, Si[O—N═C(CH₃)CH₂CH₃]₄, and CH₂═CHSi[O—N═C(CH₃)CH₂CH₃]₃; organoacetamidosilanes such as CH₃Si[NHC(═O)CH₃]₃ and C₆H₅Si[NHC(═O)CH₃]₃; aminosilanes such as CH₃Si[NH(s-C₄H₉)]₃ and CH₃Si(NHC₆H₁₁)₃; epoxyfunctional silanes such as 3-glycidoxypropyltrimethoxysilane; and organoaminooxysilanes.

A suitable condensation-curable silicone composition can also contain a condensation catalyst to initiate and accelerate the condensation reaction. Examples of condensation catalysts include, but are not limited to, amines; complexes of lead, tin, zinc, and iron with carboxylic acids; organotitanates; and organo-oxy compounds of titanium, zirconium and aluminum, bismuth or hafnium. Examples of organotitanates include, but are not limited to, tetraalkyltitanates such as tetrabutyltitanate, tetraisopropyltitanate, tetramethyltitanate, and tetraoctyltitanate; and chelated titanium compounds such as diisopropoxy titanium bis-(ethyl acetoacetonate), diisopropoxy titanium bis-(methyl acetoacetonate), diisopropoxy titanium bis-(acetylacetonate), dibutoxy titanium bis-(ethyl acetoacetonate), and dimethoxy titanium bis-(methyl acetoacetonate). Particularly useful are chelated, partially chelated or non-chelated alkoxytitanates and alkoxyzirconate compounds, where the chelating groups are dicarbonyl compounds such as β-diketones or β-keto-esters. Also particularly useful are tin(II) octoates, laurates, and oleates, as well as the salts of dibutyl tin. The condensation-curable silicone composition can be a one-part composition or a multi-part composition comprising the components in two or more parts. For example, room-temperature vulcanizable (RTV) compositions can be formulated as one-part or two-part compositions. In the two-part composition, one of the parts typically includes a small amount of water.

Suitable epoxy-curable silicone compositions typically comprise (i) an organopolysiloxane containing an average of at least two epoxy-functional groups per molecule and (ii) a curing agent. Examples of epoxy-functional groups include 2-glycidoxyethyl, 3-glycidoxypropyl, 4-glycidoxybutyl, 2,(3,4-epoxycyclohexyl)ethyl, 3-(3,4-epoxycyclohexyl)propyl, 2,3-epoxypropyl, 3,4-epoxybutyl, and 4,5-epoxypentyl. Examples of curing agents include anhydrides such as phthalic anhydride, hexahydrophthalic anhydride, tetrahydrophthalic anhydride, and dodecenylsuccinic anhydride; polyamines such as diethylenetriamine, triethylenetetramine, diethylenepropylamine, N-(2-hydroxyethyl)diethylenetriamine, N,N′-di(2-hydroxyethyl)diethylenetriamine, m-phenylenediamine, methylenedianiline, aminoethyl piperazine, 4,4-diaminodiphenyl sulfone, benzyldimethylamine, dicyandiamide, and 2-methylimidazole, and triethylamine; Lewis acids such as boron trifluoride monoethylamine; polycarboxylic acids; polymercaptans; polyamides; and amidoamines.

Suitable ultraviolet radiation-curable silicone compositions typically comprise (i) an organopolysiloxane containing radiation-sensitive functional groups and (ii) a photoinitiator. Examples of radiation-sensitive functional groups include acryloyl, methacryloyl, mercapto, epoxy, and alkenyl ether groups. The type of photoinitiator depends on the nature of the radiation-sensitive groups in the organopolysiloxane. Examples of photoinitiators include diaryliodonium salts, sulfonium salts, acetophenone, benzophenone, and benzoin and its derivatives.

Suitable high-energy radiation-curable silicone compositions typically comprise an organopolysiloxane polymer. Examples of organopolyosiloxane polymers include polydimethylsiloxanes, poly(methylvinylsiloxanes), and organohydrogenpolysiloxanes. Examples of high-energy radiation include γ-rays and electron beams.

The provided curable silicone compositions may optionally comprise additional components, provided that such components do not adversely affect the desired properties of the cured products or oxidized products thereof. Examples of additional components include, but are not limited to, adhesion promoters, solvents, inorganic fillers, photosensitizers, antioxidants, stabilizers, pigments, void reductants and surfactants. Examples of inorganic fillers include, but are not limited to, natural silica such as crystalline silica, ground crystalline silica, and diatomaceous silica; synthetic silicas such as fused silica, silica gel, pyrogenic silica, and precipitated silica; silicates such as mica, wollastonite, feldspar, and nepheline syenite; metal oxides such as aluminum oxide, titanium dioxide, magnesium oxide, ferric oxide, beryllium oxide, chromium oxide, and zinc oxide; metal nitrides such as boron nitride, silicon nitride, and aluminum nitride, metal carbides such as boron carbide, titanium carbide, and silicon carbide; carbon black; graphite; alkaline earth metal carbonates such as calcium carbonate; alkaline earth metal sulfates such as calcium sulfate, magnesium sulfate, and barium sulfate; molybdenum disulfate; zinc sulfate; kaolin; talc; glass fiber; glass beads such as hollow glass microspheres and solid glass microspheres; aluminum trihydrate; asbestos; and metallic powders such as aluminum, copper, nickel, iron, and silver powders.

### II. Silicon Additives

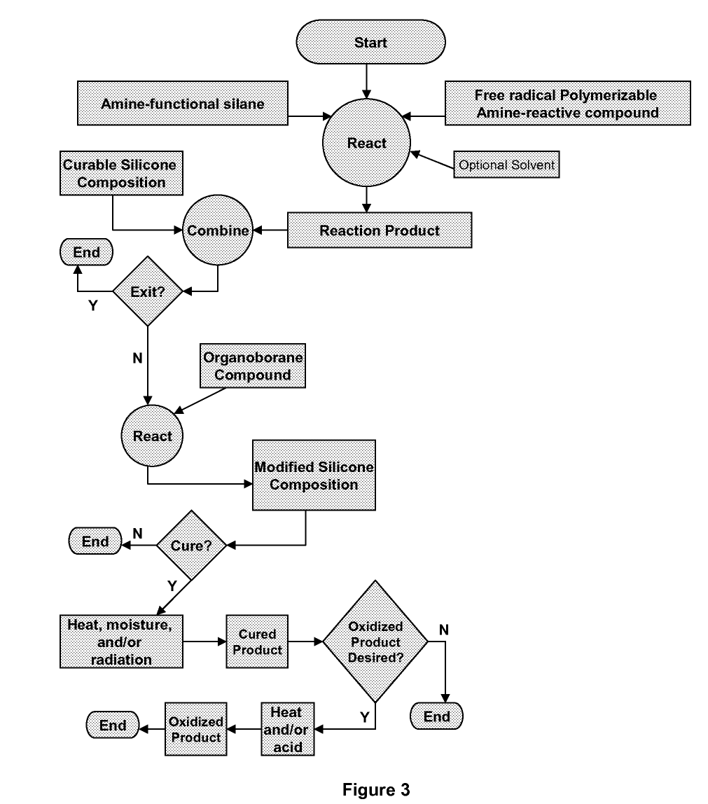

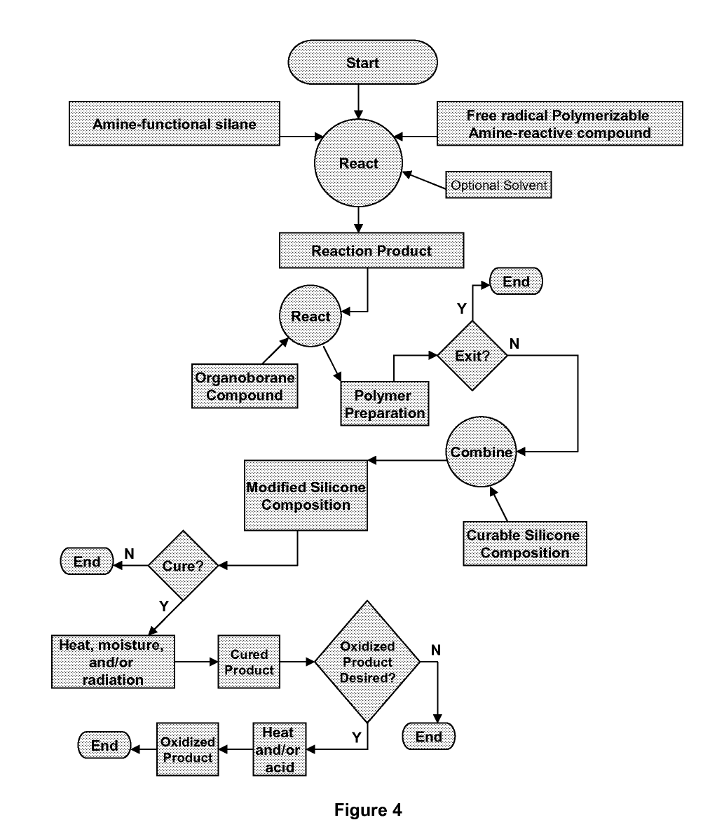

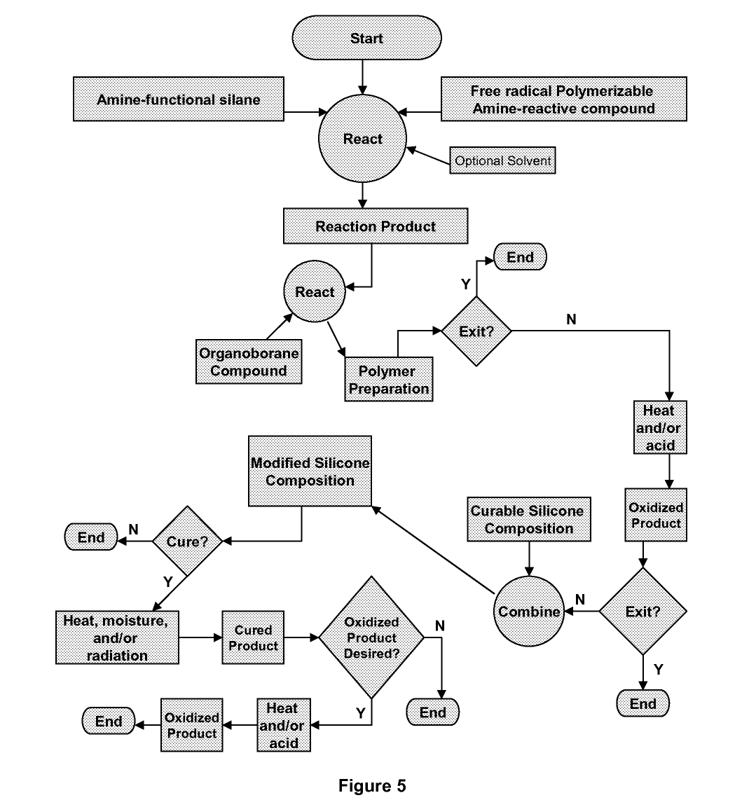

The provided modified silicone compositions comprise at least one curable silicone composition and at least one silicon additive. Suitable silicon additives may be selected from (i) an additive prepared in situ by combining a free-radical polymerizable amine-reactive compound, an amine-functional silane, and an organoborane free-radical initiator in the presence of oxygen and the curable silicone composition (as illustrated in FIG. 2), wherein the amine-reactive compound and amine-functional silane react to form a reaction product that undergoes an organoborane-polymerized reaction to form the silicon additive in the presence of the curable silicone composition; (ii) an additive prepared by combining an organoborane free-radical initiator and a reaction product of a free-radical polymerizable amine-reactive compound and an amine-functional silane in the presence of oxygen and the curable silicone composition (as illustrated in FIGS. 1 and 3), wherein the reaction product undergoes an organoborane-polymerized reaction to form the silicon additive in the presence of the curable silicone composition; (iii) an additive that is a polymer preparation prepared (as illustrated in FIGS. 1 and 4) by treating a reaction product of a free-radical polymerizable amine-reactive compound and an amine-functional silane with an organoborane free-radical initiator in the presence of oxygen; (iv) a silicon additive that is an oxidized product prepared (as illustrated in FIGS. 1 and 5) by treating a polymer preparation (prepared by treating a reaction product of a free-radical polymerizable amine-reactive compound and an amine-functional silane with an organoborane free-radical initiator in the presence of oxygen) with heat, acid, or a combination thereof; and (v) combinations thereof.

### A. Amine-Reactive Compounds

Preparation of the provided silicon additives comprises reacting an amine-reactive compound having at least one free-radical polymerizable group per molecule with one or more amine-functional silanes. The amine-reactive compound may be a small molecule, a monomer, an oligomer, a polymer, or a mixture thereof. The amine-reactive compound may be an organic, or organopolysiloxane compound. In addition to comprising at least one free-radical polymerizable group per molecule, the provided amine-reactive compound may also comprise additional functional groups, such one or more hydrolyzable groups.

In some embodiments, amine-reactive compounds may be selected from mineral acids, Lewis acids, carboxylic acids, carboxylic acid derivatives such as anhydrides and succinates, carboxylic acid metal salts, isocyanates, aldehydes, epoxides, acid chlorides and sulphonyl chlorides. Examples of amine-reactive compounds having at least one free radical polymerizable group include, but are not limited to, acrylic acid, methacrylic acid, 2-carboxyethyl acrylate, 2-carboxyethylmethacrylate, methacrylic anhydride, acrylic anhydride, undecylenic acid, methacryloylisocyanate, 2-(methacryloyloxy)ethyl acetoacetate, undecylenic aldehyde, dodecyl succinic anhydride, glycidyl acrylate and glycidyl methacrylate.

In some embodiments, it is contemplated that the amine-reactive compound may be an organosilane or organopolysiloxane oligomers bearing one or more amine-reactive groups and at least one free radical polymerizable group. Examples include, but are not limited to, silanes and oligomeric organopolysiloxanes bearing both an acrylic functional group such as methacryloxypropyl and amine reactive group such as carboxypropyl, carboxydecyl or glycidoxypropyl. Routes to synthesizing such compounds by functionalization of the corresponding silicon hydride or silicon alkoxide functional silanes or organopolysiloxane oligomers are known to one of skill in the art.

While numerous amine-reactive compounds are contemplated to be useful, one of skill in the art will recognize that the selection of a specific free radical polymerizable amine-reactive compound will depend upon, among other things, the nature of the amine-functional silane and the desired reaction product. In some embodiments, the amine-reactive compound may be selected from acrylic acid, methacrylic acid, 2-carboxyethylacrylate, 2-carboxyethylmethacrylate, glycidyl acrylate and glycidyl methacrylate. Good results have been obtained when the amine-reactive compound used is selected from acrylic acid and methacrylic acid.

In optional embodiments, it may also be desirable to react at least one additional amine-reactive compound with the amine-functional silane. For example, in addition to the amine-reactive compound described above, it may be desirable to introduce a second amine-reactive compound having at least one free-radical polymerizable group per molecule to assist in completing the desired reaction. As another example, it may be desirable to introduce an amine-reactive compound without a free-radical polymerizable group to assist in completing the desired reaction. Examples of such optional second amine reactive compounds include, but are not limited to, acetic acid, citric acid, hydrochloric acid, maleic anhydride, dedecyl succinic anhydride, 3-isocyantopropyltriethoxysilane, 3-isocyanato propyltrimethoxysilane, and (isocyanatomethyl)methyldimethoxysilane.

### B. Amine-Functional Silanes

Preparation of the provided silicon additives comprises reacting an amine-reactive compound with one or more amine-functional hydrolysable silanes having the formula:

(R¹₂NR²)ₐSiR³_{b}(OR⁴)_{4-(a+b)} (I)

wherein a=1, 2, or 3; b=0, 1, 2, or 3; a+b=1, 2, 3, or 4; R¹ is independently selected from hydrogen, C1-C12 alkyl, halogen-substituted C1-C12 alkyl, C1-C12 cycloalkyl, aryl, nitrogen-substituted C1-C12 alkyl, and aliphatic ring structures which bridge both R¹ units and can be N-substituted; R² is independently selected from C1-C30 alkyl; R³ is independently selected from hydrogen, halogen, C1-C12 alkyl, halogen-substituted C1-C12 alkyl, and —OSiR^{3′}₃, wherein R^{3′} is selected from C1-C12 alkyl, and halogen-substituted C1-C12 alkyl; and R⁴ is independently selected from hydrogen, C1-C12 alkyl, and halogen-substituted C1-C12 alkyl.

Examples of groups represented by R¹ include, but are not limited to, methyl, ethyl, n-propyl, isopropyl, n-butyl, isobutyl, sec-butyl, t-butyl, and cyclohexyl groups, and halogenated derivatives thereof. R¹ may also be N-(2-aminoethyl), N-(6-aminohexyl), or N-3-(aminopropylenoxy). Additionally two R¹ groups may be bridged through a cyclic ring, which when included with the N can form a pyridyl, pyrrole or azole substituent. Examples of groups represented by R² include, but are not limited to, vinyl, allyl, isopropenyl, n-butenyl, sec-butenyl, isobutenyl, and t-butenyl groups, and halogenated derivatives thereof. Examples of groups represented by R³ include, but are not limited to, hydrogen, halogen, methyl, ethyl, n-propyl, isopropyl, n-butyl, isobutyl, sec-butyl, t-butyl groups, trimethylsiloxy, triethylsiloxy, and halogenated derivatives thereof. Examples of groups represented by R⁴ include, but are not limited to, methyl, ethyl, n-propyl, isopropyl, n-butyl, isobutyl, sec-butyl, and t-butyl groups, and halogenated derivatives thereof.

The provided silanes comprise at least one “hydrolyzable group,” which is any group attached to silicon that may undergo a hydrolysis reaction. Suitable groups include, but are not limited to, hydrogen, halogen, and alkoxy groups.

Examples of suitable amine-functional silanes for use in the provided methods include, but are not limited to, aminomethyltriethoxysilane; aminomethyltrimethoxysilane; 3-aminopropyltriethoxysilane; 3-aminopropyltrimethoxysilane; 3-aminopropylmethyldimethoxysilane; 3-aminopropylmethyldiethoxysilane; 3-aminopropylethyldimethoxysilane; 3-aminopropylethyldiethoxysilane; 3-aminopropyl dimethylmethoxysilane; 3-aminopropyldiethylmethoxysilane; 3-aminopropyl dimethylethoxysilane; 3-aminopropyldiethylethoxysilane; n-butylaminopropyltrimethoxysilane; 4-aminobutyltriethoxysilane; 4-aminebutyltrimethoxysilane; aminophenyltrimethoxysilane; N,N-diethyl-3-aminopropyltrimethoxysilane; N-(2-aminothyl)-3-aminopropyltrimethoxysilane; 3-aminopropyl trimethylsilane, m-aminophenyltrimethoxysilane, p-aminophenyltrimethoxysilane, 11-aminoundecyltriethoxysilane; 2-(4-pyridylethyl)triethoxysilane, and 3-aminopropyltris(trimethylsiloxy)silane. Further examples of other amine functional compounds suitable for use in the provided methods can be found listed between pages 28-35 in the Gelest catalog entitled “Silane Coupling Agents: Coupling Across Boundaries Version 2.0,” appearing under the category of “Amino Functional Silanes,” and include compounds listed in the sub-categories of monoamine functional silanes (trialkoxy, monoamine functional silanes; water borne, monoamine functional silanes; dialkoxy, monoamine functional silanes); diamine functional silanes (monoalkoxy, diamine functional silanes; trialkoxy, diamine functional silanes; water borne, diamine functional silanes; dialkoxy, diamine functional silanes); monoalkoxy, triamine functional silanes; secondary amine functional silanes; tertiary amine functional silanes; quaternary amine functional silanes; dipodal amine functional silanes; specialty amine functional silanes; and cyclic azasilanes. Good results have been obtained with the use of 3-aminopropyltriethoxysilane, N-methyl-3-aminopropyltrimethoxysilane, n-butylaminopropyltrimethoxysilane, N,N-diethyl-3-aminopropyltrimethoxysilane, and N,N-dimethyl-3-aminopropyltrimethoxysilane.

### C. Optional Organic Solvent

Optionally, preparation of the provided silicon additives may comprise reacting an amine-reactive compound with one or more amine-functional hydrolysable silanes in the presence of at least one solvent, wherein the reaction product formed is soluble in the optional solvent.

In some embodiments, the solvent may be selected from toluene, xylene, linear siloxanes, cyclosiloxanes, hexamethyldisiloxane, octamethyltrisiloxane, pentamethyltetrasiloxane, ethyl acetate, propylene glycol methyl ether acetate (PGMEA), di(propyleneglycol)dimethyl ether, methylethyl ketone, methylisobutylketone, methylene chloride, tetrahydrofuran, 1,4-dioxane, N-methyl pyrollidone, N-methylformamide, dimethylsulfoxane, N,N-dimethylformamide, propylene carbonate, water, and combinations thereof. Good results have been obtained with the use of toluene, hexamethyldisiloxane, octamethyltrisiloxane, pentamethyltetrasiloxane and PGMEA.

### D. Organoborane Free-Radical Initiator

Preparation of the provided silicon additives comprises either (A) combining an amine-reactive compound, an amine-functional silane, and a curable silicone composition and treating the combination with an organoborane free-radical initiator in the presence of oxygen; or (B) reacting an amine-reactive compound with an amine-functional silane to form a reaction product that is either (i) combined with a curable silicone composition and then reacted with an organoborane free-radical initiator in the presence of oxygen or (ii) further reacted with an organoborane free-radical initiator in the presence of oxygen to form a polymer preparation.

An organoborane free-radical initiator is capable of generating a free radical in the presence of oxygen and initiating addition polymerization and/or crosslinking In some embodiments, a free radical may be generated (and polymerization initiated) upon heating of the organoborane initiator. In some embodiments, merely exposing the organoborane initiator to oxygen is sufficient to generate a free radical. In some embodiments, stabilized organoborane compounds, wherein the organoborane is rendered non-pyrophoric at ambient conditions, may be used with the provided methods.

In some embodiments, the organoborane free-radical initiator used may be selected from alkylborane-organonitrogen complexes that include, but are not limited to, trialkylborane-organonitrogen complexes comprising trialkylboranes having the formula BR″₃ , wherein R″ represents linear and branched aliphatic or aromatic hydrocarbon groups containing 1-20 carbon atoms. Examples of suitable trialkylboranes include, but are not limited to, trimethylborane, triethylborane, tri-n-butylborane, tri-n-octylborane, tri-sec-butylborane, tridodecylborane, and phenyldiethylborane. In other embodiments, an organoborane free-radical initiator may be selected from organosilicon-functional borane-organonitrogen complexes, such as those disclosed in WO2006073695 A1.

In some embodiments, it is contemplated that the organoborane free-radical initiator used with the provided methods may be an organoborane-organonitrogen complex having the formula:

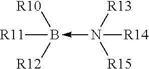

wherein B represents boron and N represents nitrogen; at least one of R10, R11, and R12 contains one or more silicon atoms with the silicon-containing group(s) covalently attached to boron; R10, R11, and R12 are groups that can be independently selected from hydrogen, a cycloalkyl group, a linear or branched alkyl group having 1-12 carbon atoms on the backbone, an alkylaryl group, an organosilane group such as an alkylsilane or an arylsilane group, an organosiloxane group, an alkene group capable of functioning as a covalent bridge to another boron atom, a divalent organosiloxane group capable of function as a covalent bridge to another boron atom, or halogen substituted homologs thereof; R13, R14, and R15 are groups that yield an amine compound or a polyamine compound capable of complexing with boron and are independently selected from hydrogen, an alkyl group containing 1-10 carbon atoms, a halogen substituted alkyl group containing 1-10 carbon atoms, or an organosilicon functional group; and at least two of the R10, R11, and R12 groups and at least two of the R13, R14, and R15 groups can combine to form heterocyclic structures, provided that the sum of the number of atoms from the two combining groups does not exceed 11.

Examples of suitable organonitrogens for forming an organoborane-organonitrogen complex include, but are not limited to, 1,3 propane diamine; 1,6-hexanediamine; methoxypropylamine; pyridine; isophorone diamine; and silicon-containing amines such as 3-aminopropyltrimethoxysilane, 3-aminopropyltriethoxysilane, 2-(trimethoxysilylethyl)pyridine, aminopropylsilanetriol, 3-(m-aminophenoxy)propyltrimethoxysilane, 3-aminopropyldiisopropylmethoxysilane, aminophenyltrimethoxysilane, 3-aminopropyltris(methoxyethoxethoxy)silane, N-(2-aminoethyl)-3-aminopropyltrimethoxysilane, N-(6-aminohexyl)aminomethyltrimethoxysilane, N-(2-aminoethyl)-h I-aminoundecyltrimethoxysilane, (aminoethylaminomethyl)-p-benethyltrimethoxysilane, N-(2-aminoethyl)-3-aminopropylmethyldimethoxysilane, N-(2-aminoethyl)-3-aminoisobutylmethyldimethoxysilane, and (3-trimethoxysilylpropyl)diethylene-triamine.

In some embodiments, nitrogen-containing compounds that may be useful for forming an organoborane-organonitrogen complexes may be selected from organopolysiloxanes having least one amine functional group. Examples of suitable amine functional groups include, but are not limited to, 3-aminopropyl, 6-aminohexyl, 11-aminoundecyl, 3-(N-allylamino)propyl, N-(2-aminoethyl)-3-aminopropyl, N-(2-aminoethyl)-3-aminoisobutyl, p-aminophenyl, 2-ethylpyridine, and 3-propylpyrrole.

Other nitrogen-containing compounds that may be useful for forming the organoborane-organonitrogen complexes for use as organoborane free-radical initiators in the provided methods may include, but are not limited to, N-(3-triethyoxysilylpropyl)-4,5-dihydroimidazole, ureidopropyltriethoxysilane, and organopolysiloxane resins in which at least one group is an imidazole, amidine, or ureido functional group.

In some embodiments, an organoborane free radical initiator for use in the provided methods may be a trialkylborane-organonitrogen complex wherein the trialkylborane is selected from triethylborane, tri-n-butylborane, tri-n-octylborane, tri-sec-butylborane, and tridodecylborane. For example, an initiator may be selected from triethylborane-propanediamine, triethylborane-butylimidazole, triethylborane-methoxypropylamine, tri-n-butyl borane-methoxypropylamine, triethylborane-isophorone diamine, tri-n-butyl borane-isophorone diamine, and triethylborane-aminosilane or triethylborane-aminosiloxane complexes. Good results have been obtained with use of TnBB-MOPA (tri-n-butyl borane complexed with 3-methoxypropylamine).

Although organonitrogen-stabilized organoborane compounds are particularly useful as free radical initiators, one of skill in the art will understand that other organoborane free radical initiators may be used. Examples may include, but are not limited to, ring stabilized compounds (such as 9-BBN), or solvent complexed organoboranes (such as trialkylborane-THF solutions).

In various embodiments, a free radical may be generated, and polymerization and/or crosslinking is initiated, by exposing the organoborane free radical initiator to air (or other oxygen source), heat, radiation, or combinations thereof. In the case of thermal activation, the temperature required to initiate polymerization and/or crosslinking reactions is dictated by the nature of the organoborane compound selected as the initiator. For example, if an organoborane-organonitrogen complex is selected, the binding energy of the complex will dictate the necessary temperature required to initiate dissociation of the complex and the reaction. In some embodiments, the organoborane free radical initiator and the reaction product of the silane and amine-reactive compound are heated together. In some embodiments, no heat is required to initiate polymerization and/or crosslinking

### III. Polymer Preparations and Oxidized Products Thereof

In some embodiments, a modified silicone composition comprises a curable silicone composition and a silicon additive, wherein the silicon additive may be prepared by a method comprising reacting an amine-functional silane and an amine-reactive compound to form a reaction product and reacting the reaction product with an organoborane free-radical initiator in the presence of oxygen to form a polymer preparation. In some embodiments, the polymer preparation formed may either (i) be subsequently combined with a curable silicone composition to form a modified silicone composition; or (ii) oxidized by heat, acid, or both. The oxidized polymer preparation may also be combined with a curable silicone composition to form a modified silicone composition.

### IV. Methods

Provided are methods of preparing modified silicone compositions, cured products of said compositions and oxidized products thereof, as well as membranes comprising one or both of the provided cured products and oxidized products. The modified silicone compositions are prepared by a method comprising combining at least one curable silicone composition and at least one silicon additive. In some embodiments, preparation of the silicon additive occurs in situ when a free radical polymerizable amine-reactive compound, an amine-functional silane, and a curable silicone composition are combined and treated with an organoborane free radical initiator in the presence of oxygen. In some embodiments, preparation of the silicon additive comprises reacting a free radical polymerizable amine-reactive compound with an amine-functional silane to form a reaction product. The reaction product may be, but is not required to be, an amine-carboxylate salt or amide bridged complex. Optionally, the reaction occurs in the presence of at least one solvent to form a reaction product that is soluble in the solvent. The reaction product formed is further reacted with an organoborane free-radical initiator in the presence of oxygen.

In various embodiments, a desirable silicon additive may be prepared when the mole ratio of the amine groups in the silane to the amine-reactive groups in the amine reactive compound is from about 0.5 to about 1.5. Accordingly, suitable mole ratios (amine groups/amine-reactive groups) may be 0.5-0.6, 0.6-0.7, 0.7-0.8, 0.8-0.9, 0.9-1.0, 1.0-1.1, 1.1-1.2, 1.2-1.3, 1.3-1.4, 1.4-1.5, and all points therein. Good results have been obtained when the mole ratio is from 1.0 to 1.5.

Free radical generation with organoborane initiators requires oxygen, which may be present in the ambient air, dissolved in the precursor and/or organoborane compositions, or delivered from another oxygen source. In some embodiments, limiting the concentration of oxygen (but not precluding it from the system) such as by the use of a nitrogen sweep or purge may be advantageous for safety (reduced flammability of volatile fluids), for reaction efficiency, or both. In some embodiments, the reaction product formed is combined with a curable silicone composition prior to its reaction with the organoborane compound. In such embodiments, reaction of the reaction product with the organoborane forms a modified silicone composition. In alternative embodiments, the reaction product is directly reacted with the organoborane compound to form a polymer preparation. In some embodiments, the polymer preparation formed may be combined with a curable silicone composition to form a modified silicone composition. In alternative embodiments, the polymer preparation formed may be used to prepare an oxidized solid, powder, or combination thereof by treatment with heat, acid, or combinations thereof. The oxidized solid or oxidized powder formed may be combined with a curable silicone composition to form a modified silicone composition.

In some embodiments, a modified silicone composition is prepared by combining a curable silicone composition with a provided oxidized solid. A silicon additive that is an oxidized solid may be prepared by treating the provided polymer preparation with high heat or at least one strong acid. Alternatively, an oxidized solid may be prepared by treating the provided polymer preparation with at least one strong acid and low heat. In further embodiments, an oxidized solid may be formed by applying low heat and a vacuum to the polymer preparation to form a bulk solid and then treating the bulk solid with high heat or at least one strong acid to form the oxidized solid. Alternatively, low heat can be applied to the polymer preparation to form a bulk solid that can be subsequently treated with low heat and at least one strong acid to form the oxidized solid.

Heating a polymer preparation or a bulk solid to a temperature of from about 400° C. to about 1000° C. is generally sufficient to form an oxidized solid. Accordingly, suitable temperatures may be 400° C.-450° C., 450° C.-500° C., 500° C.-550° C., 550° C.-600° C., 600° C.-650° C., 650° C.-700° C., 700° C.-750° C., 750° C.-800° C., 800° C.-850° C., 850° C.-900° C., 900° C.-950° C., 950° C.-1000° C., and all points therein. Good results have been obtained by heating to a temperature of from about 500° C. to about 700° C. Good results have also been obtained by heating to a temperature of from about 550° C. to about 650° C. In some embodiments, preparation of an oxidized solid comprises contacting a provided polymer preparation or bulk solid with at least one acid. Examples of suitable acids include, but are not limited to, strong acids such as hydrochloric (HCl), hydrobromic (HBr), hydroiodic (HI), nitric (HNO₃), perchloric (HClO₄), and sulfuric (H₂SO₄) acids. Good results have been obtained by using HCl.

In some embodiments, a modified silicone composition is formed by combining a curable silicone composition with an oxidized powder. A silicon additive that is an oxidized powder may be prepared by granulating a provided oxidized solid. Alternatively, an oxidized powder can be prepared by granulating a provided bulk solid and then treating the granulated solid with acid, heat, or combinations thereof. For example, granulated bulk solid may be treated with high heat or at least one strong acid to form the oxidized powder. As another example, granulated bulk solid may be treated with low heat and at least one strong acid to form the oxidized powder. Heating a granulated bulk solid to a temperature of from about 400° C. to about 1000° C. is generally sufficient to form an oxidized powder. Accordingly, suitable temperatures may be 400° C.-450° C., 450° C.-500° C., 500° C.-550° C., 550° C.-600° C., 600° C.-650° C., 650° C.-700° C., 700° C.-750° C., 750° C.-800° C., 800° C.-850° C., 850° C.-900° C., 900° C.-950° C., 950° C.-1000° C., and all points therein. Good results have been obtained by heating to a temperature of from about 500° C. to about 700° C. Good results have also been obtained by heating to a temperature of from about 550° C. to about 650° C. Contacting a granulated bulk solid with at least one acid selected from hydrochloric (HCl), hydrobromic (HBr), hydroiodic (HI), nitric (HNO₃), perchloric (HClO₄), and sulfuric (H₂SO₄) acids is generally sufficient to form an oxidized powder. Good results have been obtained by using HCl.

The oxidized solids and powders prepared by the provided methods are porous. Such porous solids and powders may be microporous (having a mean pore diameter of less than 2 nm), mesoporous (having a mean pore diameter of from about 2 nm-50 nm), or macroporous (having a mean pore diameter of greater than 50 nm). Thus, in some embodiments, the provided porous solids and powders may have a mean pore diameter selected from <1 nm, 1-1.2 nm, 1.2-1.4 nm, 1.4-1.6 nm, 1.6-1.8 nm, 1.8-2 nm, 2-5 nm, 5-10 nm, 10-15 nm, 15-20 nm, 20-25 nm, 25-30 nm, 30-35 nm, 35-40 nm, 40-45 nm, 45-50 nm, 50-70 nm, 70-90 nm, 90-110 nm, and all points therein. In some embodiments, the provided porous solids and powders may have a mean pore diameter greater than 110 nm. For example, it is contemplated that mean pore diameter may be selected from about 110-500 nm, 500-1000 nm (1 μm), 1-10 μm, 10-20 μm, 20-30 μm, 30-40 μm, and 40-50 μm.

### V. Cured Products of Modified Silicone Compositions and Oxidized Products Thereof

The provided modified silicone compositions comprise (I) at least one curable silicone composition and (II)) at least one silicon additive selected from (i) an additive prepared in situ by combining a free-radical polymerizable amine-reactive compound, an amine-functional silane, and an organoborane free-radical initiator in the presence of oxygen and the curable silicone composition; (ii) an additive prepared by combining an organoborane free-radical initiator and a reaction product of a free-radical polymerizable amine-reactive compound and an amine-functional silane in the presence of oxygen and the curable silicone composition; (iii) an additive that is a polymer preparation prepared by treating a reaction product of a free-radical polymerizable amine-reactive compound and an amine-functional silane with an organoborane free-radical initiator in the presence of oxygen; (iv) a silicon additive that is an oxidized product prepared by treating a polymer preparation of (iii) with heat, acid, or a combination thereof; and (v) combinations thereof.

In various embodiments, the provided modified silicone compositions may be cured. Cure of modified silicone compositions may be achieved by exposing a provided modified silicone composition to ambient temperature (approximately 21±4° C.), elevated temperature (from about 40 to about 200° C.), moisture (for example, from about 10 to 100% relative humidity), or radiation, depending at least in part, upon the nature of the curable silicone composition component. For example, modified silicone compositions comprising one-part hydrosilylation-curable silicone compositions may typically be cured at an elevated temperature, whereas compositions comprising two-part hydrosilylation-curable silicone compositions may typically be cured at room temperature or at an elevated temperature. As another example, modified silicone compositions comprising one-part condensation-curable silicone compositions may typically be cured by exposure to relative humidity levels of about 20% at room temperature, although cure can be accelerated by application of elevated temperature and/or exposure to higher humidity levels (for example, 60% relative humidity). Modified silicone compositions comprising two-part condensation-curable silicone compositions may typically be cured at room temperature, but cure can typically be accelerated by application of elevated temperature. As another example, modified silicone compositions comprising peroxide-curable silicone compositions may typically be cured at an elevated temperature. Similarly, modified silicone compositions comprising epoxy-curable silicone compositions may typically be cured at room temperature or at an elevated temperature. Depending on the particular formulation, modified silicone compositions comprising radiation-curable silicone compositions may typically be cured by exposure to radiation, using for example, ultraviolet light, gamma rays, or electron beams. One of skill in the art will appreciate that a variety of parameters, including bulb type (Hg or LED), light intensity, exposure time (line speed), film thickness, photoinitiator type and concentration, photosensitizer type and concentration, and atmospheric oxygen concentration may be used to control cure rate of radiation-curable silicone compositions.

In various embodiments, it is contemplated that the cured products of the provided modified silicone compositions may be further treated with heat, acid, or both to form an oxidized product. For example, it is contemplated that oxidized products may be formed by treating the provided cured products of the modified silicone compositions with high heat or at least one strong acid. As another example, it is contemplated that oxidized products may be formed by treating the provided cured products with at least one strong acid and low heat. In some embodiments, preparation of an oxidized product may comprise heating a provided cured product to a temperature of from about 400° C. to about 1000° C. Accordingly, suitable temperatures may be 400° C.-450° C., 450° C.-500° C., 500° C.-550° C., 550° C.-600° C., 600° C.-650° C., 650° C.-700° C., 700° C.-750° C., 750° C.-800° C., 800° C.-850° C., 850° C.-900° C., 900° C.-950° C., 950° C.-1000° C., and all points therein. In some embodiments, preparation of an oxidized product may comprise contacting a provided cured product with at least one acid. Examples of suitable acids include, but are not limited to, strong acids such as hydrochloric (HCl), hydrobromic (HBr), hydroiodic (HI), nitric (HNO₃), perchloric (HClO₄), and sulfuric (H₂SO₄) acids.

### VI. Membranes and Methods of Separating Gases

In various embodiments, provided are membranes comprising (i) cured products of the provided modified silicone compositions; (ii) oxidized products of cured products of the provided modified silicone compositions; or (iii) combinations thereof. Said membranes may be processed into common membrane forms such as thin films and fibers, which can be free standing or supported. The resulting membrane forms can be assembled into a variety of configurations useful for gas separations such as hollow fiber membrane modules, spiral-wound membrane modules, flat membrane modules, and substantially flat membrane modules. Methods of processing membranes into films and fibers and methods of assembling membrane forms into configurations useful for gas separations are generally known in the art.

The provided membranes have the requisite permeability and selectivity for separating mixtures of gases. For example, the provided membranes may be contacted with a mixture of two or more gases, wherein at least one gas passes preferentially through the membrane at a substantially higher rate than at least one other gas. Thus, the provided membranes may be used for separating mixtures of gases, as well as for enriching a gas mixture with at least one gas. In some embodiments, the provided membranes may be contacted with a mixture of at least two gases selected from carbon dioxide, nitrogen, methane, hydrogen, oxygen, hydrogen sulfide, carbon monoxide, water vapor, and hydrocarbons.

### EXAMPLES

The present invention will be better understood by reference to the following examples which are offered by way of illustration and which one of skill in the art will recognize are not meant to be limiting.

### Example 1

### Curable Silicone Composition

Part A of a silicone composite was prepared by combining 49.85 g of a dimethylvinylsiloxy-terminated polydimethylsiloxane having a viscosity of about 55 Pa.s at 25° C. (“PDMS 1”) and 0.195 g of a catalyst comprising a mixture of 1% of a platinum(IV) complex of 1,1-diethenyl-1,1,3,3-tetramethyldisiloxane, 92% of dimethylvinylsiloxy-terminated polydimethylsiloxane having a viscosity of about 0.45 Pa.s at 25° C., and 7% of tetramethyldivinyldisiloxane (“Catalyst”) in a polypropylene cup. The components were mixed for two consecutive 30-second cycles using a FlackTek Speed Mixer DAC 150 dental mixer. Part B was prepared by combining 49.30 g of PDMS 1, 0.660 g of a polydimethylsiloxane-polyhydridomethylsiloxane copolymer having an average viscosity of 0.005 Pa.s at 25° C. and comprising 0.7 wt % H in the form of SiH (“Crosslinker 1”), and 0.205 g of 2-methyl-3-butyn-2-ol in a polypropylene cup. The components were mixed for two consecutive 30-second cycles using a FlackTek Speed Mixer DAC 150 dental mixer.

### Example 2

### Silicon Additive

25.42 g of 3-aminopropyltriethoxysilane was added to a glass jar. The glass jar was then placed in an ice-bath while the content was being agitated with a magnetic stir bar. 9.89 g of methacrylic acid was measured out separately and was added drop-wise to the glass jar over a period of 5 minutes. The mixture was stored under nitrogen.

### Example 3

### Modified Silicone Composition and Membrane

Part A of Example 1 (0.47 parts), part B of Example 1 (0.47 parts), and the mixture of Example 2 (0.06 parts) were combined in a polypropylene cup. The components were mixed for two consecutive 30-second cycles using a FlackTek Speed Mixer DAC 150 dental mixer. 9.00 g of this mixture was then transferred to a second 1-oz polypropylene cup along with 0.54 g of a hydridosiloxy functional siloxane resin consisting essentially of (CH3)3SiO1/2 units, (CH3)2HSiO1/2 units and SiO4/2 units wherein the ratio of (CH3)2HSiO1/2 units to SiO4/2 units is approximately 1.82, comprises 1 wt % H in the form of SiH and has an average viscosity of 0.02 Pa.s at 25° C. (“Crosslinker 2”), 0.36 g of a stabilized adduct of tri-n-butyl borane complexed with 1.3 equivalents of 3-methoxypropylamine (TnBB-MOPA), and 0.72 g of Catalyst. The components were mixed for two consecutive 30-second cycles using a FlackTek Speed Mixer DAC 150 dental mixer. The mixture was then placed on a fluorosilicone coated PET substrate and drawn down to a thin film using a BYK-Additives & Instruments Byko-Drive Automatic Film Applicator equipped with a 4 mil draw-down bar. The film was then placed in a 80° C. oven and cured for 24 hours. The cured silicone composition was then peeled off of the substrate and the gas permeation properties were tested using a 50/50 (mass) mixture of CO₂ and N₂ in a permeation cell. The CO₂ permeation coefficient of the cured silicone composition was measured by the method described below. The composition showed a CO₂ permeation coefficient of 2890 Barrers and a CO₂/N₂ ideal separation factor of 10.81.

Permeability Measurement. The permeation cell used comprised an upstream (feed side) and downstream (permeate side) chambers separated by the membrane. Each chamber had one gas inlet and one gas outlet. The upstream chamber was maintained at 35 psi pressure and constantly supplied with a 50/50 (mass) mixture of CO₂ and N₂ at a flow rate of 200 sccm. The downstream chamber was maintained at 5 psi pressure and is constantly supplied with a pure He stream at a flow rate of 20 sccm. To analyze the permeability and separation factor of the membrane, the outlet of the downstream chamber was connected to a 6-port injector equipped with a 1-mL injection loop. On command, the 6-port injector injected a 1-mL sample into a gas chromatograph (GC) equipped with a thermal conductivity detector (TCD). The amount of gas permeated through the membrane was calculated by calibrating the response of the TCD detector to the gases of interest. The reported values of gas permeability and selectivity were obtained from measurements taken after the system had reached a steady state in which the permeate side gas composition became invariant with time. All experiments are run at ambient laboratory temperature (21+/2° C.).

### Example 4

### Silicon Additive

25.36 g of (N-methyl-3-aminopropyl)trimethoxysilane was added to a glass jar. The glass jar was then placed in an ice-bath while the content was being agitated with a magnetic stir bar. 11.03 g of methacrylic acid was measured out separately and was added drop-wise to the glass jar over a period of 5 minutes. The mixture was stored under nitrogen.

### Example 5

### Modified Silicone Composition and Membrane

Part A of Example 1 (0.47 parts), part B of Example 1 (0.47 parts), and the mixture of Example 4 (0.06 parts) were combined in a 1-oz polypropylene cup. The components were mixed for two consecutive 30-second cycles using a FlackTek Speed Mixer DAC 150 dental mixer. 9.00 g of this mixture was then transferred to a second 1-oz polypropylene cup along with 0.54 g of Crosslinker 2, 0.36 g of TnBB-MOPA, and 0.73 g of Catalyst. The components were mixed for two consecutive 30-second cycles using a FlackTek Speed Mixer DAC 150 dental mixer. The mixture was then placed on a fluorosilicone coated PET substrate and drawn down to a thin film using a BYK-Additives & Instruments Byko-Drive Automatic Film Applicator equipped with a 4 mil draw-down bar. The film was then placed in a 80° C. oven and cured for 24 hours. The cured silicone composition was then peeled off of the substrate and the gas permeation properties were tested using a 50/50 (mass) mixture of CO₂ and N₂ in the permeation cell described in Example 3. The cured silicone composition showed a CO₂ permeation coefficient of 3120 Barrers and a CO₂/N₂ ideal separation factor of 9.34.

### Example 6

### Silicon Additive

25.90 g of (N,N-dimethyl-3-aminopropyl)trimethoxysilane was added to a glass jar. The glass jar was then placed in an ice-bath while the content was being agitated with a magnetic stir bar. 10.77 g of methacrylic acid was measured out separately and was added drop-wise to the glass jar over a period of 5 minutes. The mixture was stored under nitrogen.

### Example 7

### Modified Silicone Composition and Membrane

Part A of Example 1 (0.47 parts), part B of Example 1 (0.47 parts), and the mixture of Example 6 (0.06 parts) were combined in a 1-oz polypropylene cup. The components were mixed for two consecutive 30-second cycles using a FlackTek Speed Mixer DAC 150 dental mixer. 9.00 g of this mixture was then transferred to a second 1-oz polypropylene cup along with 0.89 g of Crosslinker 2, 0.36 g of TnBB-MOPA, and 0.56 g of Catalyst. The components were mixed for two consecutive 30-second cycles using a FlackTek Speed Mixer DAC 150 dental mixer. The mixture was then placed on a fluorosilicone coated PET substrate and drawn down to a thin film using a BYK-Additives & Instruments Byko-Drive Automatic Film Applicator equipped with a 4 mil draw-down bar. The film was then placed in a 80° C. oven and cured for 24 hours. The cured silicone composition was then peeled off of the substrate and the gas permeation properties were tested using a 50/50 (mass) mixture of CO₂ and N₂ in the permeation cell described in Example 3. The cured silicone composition showed a CO₂ permeation coefficient of 6040 Barrers and a CO₂/N₂ ideal separation factor of 10.41.

The present invention should not be considered limited to the specific examples described herein, but rather should be understood to cover all aspects of the invention. Various modifications and equivalent processes, as well as numerous structures and devices, to which the present invention may be applicable will be readily apparent to those of skill in the art. Those skilled in the art will understand that various changes may be made without departing from the scope of the invention, which is not to be considered limited to what is described in the specification.

1. A modified silicone composition, comprising:
(A) at least one curable silicone composition; and
(B) at least one silicon additive prepared by a method comprising reacting an amine-functional silane, an amine-reactive compound having at least one free-radical polymerizable group per molecule, and an organoborane free-radical initiator; wherein the amine-functional silane has the formula:
(R¹₂NR²)ₐSiR³_{b}(OR⁴)_{4-(a+b)} (I)
wherein a=1, 2, or 3; b=0, 1, 2, or 3; a+b=1, 2, 3, or 4; R¹ is independently selected from hydrogen, C1-C12 alkyl, halogen-substituted C1-C12 alkyl, C1-C12 cycloalkyl, aryl, nitrogen-substituted C1-C12 alkyl, and aliphatic ring structures which bridge both R¹ units and can be N-substituted; R² is independently selected from C1-C30 alkyl; R³ is independently selected from hydrogen, halogen, C1-C12 alkyl, halogen-substituted C1-C12 alkyl, and —OSiR^{3′}₃, wherein R^{3′} is selected from C1-C12 alkyl, and halogen-substituted C1-C12 alkyl; and R⁴ is independently selected from hydrogen, C1-C12 alkyl, and halogen-substituted C1-C12 alkyl.

2. A modified silicone composition according to claim 1, wherein the silicon additive is prepared in situ by a method comprising combining the amine-functional silane, the amine-reactive compound, and the organoborane free-radical initiator in the presence of oxygen and the curable silicone composition.

3. A modified silicone composition according to claim 1, wherein the silicon additive is prepared by a method comprising (i) reacting the amine-functional silane and amine-reactive compound to form a reaction product; and (ii) combining the reaction product with the organoborane free-radical initiator in the presence of oxygen and the curable silicone composition.

4. A modified silicone composition according to claim 1, wherein the silicon additive is a polymer preparation prepared by a method comprising (i) reacting the amine-functional silane and amine-reactive compound to form a reaction product; and (ii) treating the reaction product with the organoborane free-radical initiator in the presence of oxygen.

5. A modified silicone composition according to claim 1, wherein the silicon additive is an oxidized product prepared by a method comprising (i) reacting the amine-functional silane and amine-reactive compound to form a reaction product; (ii) treating the reaction product with the organoborane free-radical initiator in the presence of oxygen to form a polymer preparation; (iii) heating the polymer preparation, contacting the polymer preparation with at least one acid, or combinations thereof; and (iv) combinations thereof.

6. (canceled)

7. A modified silicone composition according to claim 5, wherein the polymer preparation is heated to a temperature of from 400° C. to 1000° C.

8. A modified silicone composition according to claim 5, wherein the silicon additive is selected from an oxidized powder and an oxidized solid.

9. A modified silicone composition according to claim 1, wherein preparation of the silicon additive occurs in the presence of at least one solvent.

10. A modified silicone composition according to claim 9, wherein the solvent is selected from toluene, xylene, linear siloxanes, cyclosiloxanes, hexamethyldisiloxane, octamethyltrisiloxane, pentamethyltetrasiloxane, ethyl acetate, propylene glycol methyl ether acetate, di(propyleneglycol)dimethyl ether, methylethyl ketone, methylisobutylketone, methylene chloride, tetrahydrofuran, 1,4-dioxane, N-methyl pyrollidone, N-methylformamide, dimethylsulfoxane, N,N-dimethylformamide, propylene carbonate, and water.

11. A modified silicone composition according to claim 1, wherein the amine-reactive compound is selected from acrylic acid, methacrylic acid, 2-carboxyethylacrylate, 2-carboxyethylmethacrylate, glycidyl acrylate, and glycidyl methacrylate.

12. A modified silicone composition according to claim 1, wherein the amine-functional silane is selected from aminomethyltriethoxysilane; aminomethyltrimethoxysilane; 3-aminopropyltriethoxysilane; 3-aminopropyltrimethoxysilane; 3-aminopropylmethyldimethoxysilane; 3-aminopropylmethyldiethoxysilane; 3-aminopropylethyldimethoxysilane; 3-aminopropylethyldiethoxysilane; 3-aminopropyl dimethylmethoxysilane; 3-aminopropyldiethylmethoxysilane; 3-aminopropyl dimethylethoxysilane; 3-aminopropyldiethylethoxysilane; n-butylaminopropyltrimethoxysilane; 4-aminobutyltriethoxysilane; 4-aminebutyltrimethoxysilane; aminophenyltrimethoxysilane; N,N-diethyl-3-aminopropyltrimethoxysilane; N-(2-aminothyl)-3-aminopropyltrimethoxysilane; 3-aminopropyl trimethylsilane, m-aminophenyltrimethoxysilane, p-aminophenyltrimethoxysilane, 11-aminoundecyltriethoxysilane; and 2-(4-pyridylethyl)triethoxysilane.

13. A modified silicone composition according to claim 1, wherein the organoborane free-radical initiator is a trialkylborane-organonitrogen complex selected from triethylborane-propanediamine, triethylborane-butylimidazole, triethylborane-methoxypropylamine, tri-n-butyl borane-methoxypropylamine, triethylborane-isophorone diamine, tri-n-butyl borane-isophorone diamine, triethylborane-aminosilanes, and triethylborane-aminosiloxanes.

14. A cured product prepared by (i) heating the modified silicone composition of claim 1; (ii) contacting the modified silicone composition of claim 1 with moisture; (iii) exposing the modified silicone composition of claim 1 to radiation; or (iv) combinations thereof.

15. An oxidized product prepared by (i) heating a cured product of claim 14; (ii) contacting the cured product of claim 14 with at least one acid; or (iii) combinations thereof.

16. A membrane comprising a cured product of claim 14 or combinations of one or more cured product of claim 14.

17. A membrane comprising an oxidized product of claim 15 or combinations of one or more oxidized product of claim 15.

18. A membrane according to claim 14, wherein the membrane is selected from a free-standing membrane and a supported membrane.

19. A membrane according to claim 18, wherein the membrane is selected from a hollow fiber membrane, a spiral-wound membrane, a flat membrane, and a substantially flat membrane.

20. A method of separating a gas mixture, comprising passing a mixture of two or more gases through a membrane of claim 16.

21. A method according to claim 20, wherein the gases are selected from carbon dioxide, nitrogen, methane, hydrogen, oxygen, hydrogen sulfide, carbon monoxide, water vapor, and hydrocarbons.
